(19) United States
(12) Patent Application Publication
(10) Pub. No.: US 2006/0120390 A1
(43) Pub. Date: Jun. 8, 2006

(54) Master node for a lin network

(76) Inventors: Hartnut Karl Habben, Hamburg (DE); Peter Hank, Hamburg (DE)

Correspondence Address: PHILIPS INTELLECTUAL PROPERTY & STANDARDS, P.O. BOX 3001, BRIARCLIFF MANOR, NY, 10510, US

(21) Appl. No.: 10/559,358

(22) PCT Filed: Jun. 1, 2004
(86) PCT No.: PCT/IB04/50812

§ 371 Date: Dec. 6, 2005

(30) Foreign Application Priority Data
Jun. 11, 2003 (EP) 03101704.9

(51) Int. Cl. G06F 15/16; H04L 12/56

(52) U.S. Cl. 370/406; 709/251; 709/208

(57) ABSTRACT

In the case of a master node (1) for a LIN network (Local Interconnect Network) (9), hardware circuits (2, 3, 4, 5) are rovided in the master node (1), which hardware circuits are provided to carry out the LIN protocol and take over the behavior of the master during data transmission or data reception without additional processor or software support.

The invention relates to a master node for a LIN network. The letters LIN stand for Local Interconnect Network. This is a low-cost system which is increasingly being used in vehicles. A LIN network typically consists of one so-called master and a number of so-called slaves. The master takes control of the LIN network during communication.

In solutions known from the prior art, standard UART controllers are used to carry out the LIN protocol which stipulates the behavior of the master and of the slaves during data transmission. The letters UART stand for Universal Asynchronous Receiver Transmitter. This is an extremely simple protocol which merely stipulates that each data block consists of 8 data bits which are preceded by a start bit and followed by a stop bit. Since most data blocks of a message of the LIN protocol correspond to this structure, it is obvious to use a standard UART controller for LIN master nodes. However, there is the problem that all those elements of the LIN protocol which go beyond the UART protocol have to be carried out by means of additional software. This includes for example the so-called Synch Break Field, which belongs to each header of a message of the LIN protocol. The comparison of transmitted data with the data received from the data bus is also not possible by means of such a standard UART controller and in solutions known from the prior art has to be carried out by means of additional software solutions. The same applies in respect of the calculation and checking of checksums which is likewise to be carried out in the node.

To summarize, in the solutions known from the prior art there is the problem that functions of the LIN protocol that are to be carried out in addition to the standard UART protocol require a relatively high programming complexity since dedicated software has to be generated for each of these functions.

It is an object of the invention to provide a master node for a LIN network which requires no software solutions and in which the entire LIN protocol is realized in as simple a manner as possible.

This object is achieved according to the invention by the features of patent claim 1:

A master node for a LIN network (Local Interconnect Network), wherein hardware circuits are provided in the master node, which hardware circuits are provided to carry out the LIN protocol and take over the behavior of the master during data transmission or data reception without additional processor or software support.

In the master node according to the invention, use is made of hardware circuits which process and carry out the entire LIN protocol. This includes both those elements of the LIN protocol which correspond to the standard UART protocol, in which a data block consists of 8 data bits and a start bit and a stop bit, and those parts of the LIN protocol which go beyond this structure. This includes in particular the Synch Break Field of the header of the LIN protocol, but also additional functions such as comparison of data and also generation and comparison of checksums. Such a master node can thus be realized in a simple manner and does not require any additional programming for adaptation to the LIN protocol, as is necessary in solutions known from the prior art for expanding the UART protocol to the LIN protocol.

According to a further refinement of the invention as claimed in claim 2, there is provided in the master node a message memory in which an application wishing to transmit data can store data. The hardware circuits provided in the master node for realizing the LIN protocol automatically retrieve these data and transmit them to the LIN network in accordance with the LIN protocol. These hardware circuits automatically store the data present in these data memories in the data received via the LIN network, so that the user can retrieve them from there. For these processes, the user does not need to provide any additional processor power or software solutions for carrying out the LIN protocol, as is necessary in the solutions known from the prior art.

The abovementioned hardware circuits, which determine the behavior of the master in the master node according to the invention during carrying out of the LIN protocol, in particular have a control unit which composes messages that are to be transmitted via the LIN network and processes messages received via this network, evaluates them and stores the part of the message for the user in the message memory. The entire control of the process of a LIN master is thus essentially carried out by means of this control unit.

According to further refinements of the invention as claimed in claims 4 and 5, a checksum generator and a hardware circuit for checksum comparison are provided. These circuits are designed to generate the checksums on account of the data that are to be transmitted or the received data, and to compare the checksums of received data with the checksum value supplied. In cases where data are to be transmitted, the generated checksum is automatically appended to the message that is to be transmitted. In this case, too, there is no need for any software control.

The hardware circuits for carrying out the LIN protocol advantageously furthermore have a comparison circuit provided as claimed in claim 6, which compares data transmitted from the master node according to the invention to the LIN network with the data which are reflected back via the LIN network. A direct comparison of those data which have actually been transmitted to the LIN network with that data generated by the master node is thus possible. This hardware circuit also does not require any software control.

According to a further refinement of the invention as claimed in claim 7, the control unit that is advantageously provided controls the remaining hardware circuits, that is to say in particular the checksum generator, the circuit for checksum comparison and the comparison circuit. The overall process control of a LIN master can thus be effected via this hardware control.

The invention will be further described with reference to an example of embodiment shown in the drawings to which, however, the invention is not restricted.

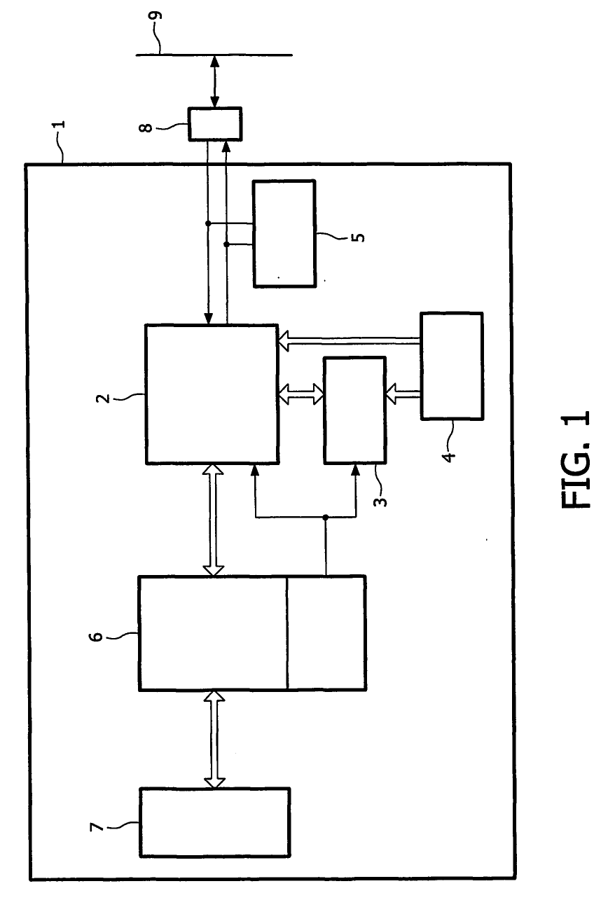

FIG. 1 shows a master node according to the invention for a LIN network and also a transceiver connected between the network and the master node.

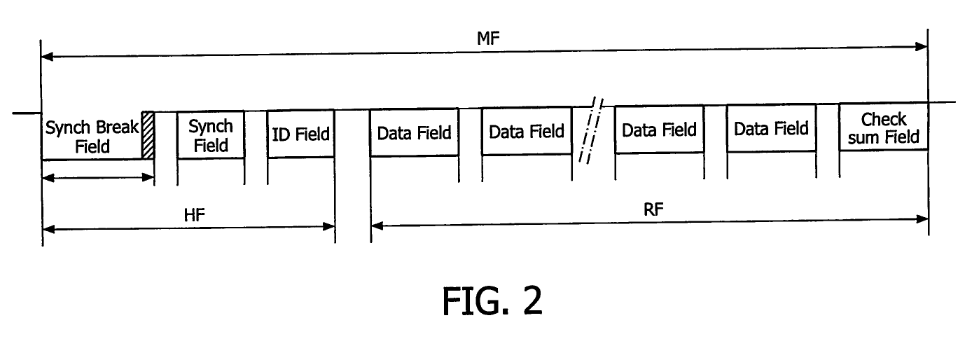

FIG. 2 shows a time diagram for a message of the master node shown in FIG. 1 that is transmitted by way of example via the LIN network.

The block diagram shown in FIG. 1 shows the master node 1 according to the invention which has a number of hardware circuits 2, 3, 4 and 5 which are designed to carry out the LIN protocol. These circuits operate automatically to carry out this protocol and do not require any external or internal software control.

In the master node 1 there is furthermore provided a data memory 6 which can exchange data with a user, not shown in the figure, via an interface 7. These data are thus either data that are to be transmitted via the LIN network or data received via the latter, which may be provided by the user (not shown in the figure) via the interface 7 and stored in the data memory 6 or may be read from the data memory 6 by said user via the interface 7.

As furthermore shown in FIG. 1, the master node 1 is coupled to the single wire 9 of the LIN network (which otherwise is not shown in the figure) via a so-called transceiver. The transceiver in this case acts as a kind of physical bridge to the LIN network. In LIN networks, the so-called master takes control, that is to say initiates the transmission of messages. The messages may be transmitted either by the master itself or by a slave.

In any case, the LIN protocol provides that each message consists of a so-called header which in turn consists of a Synch Break Field, a Synch Field and an Identifier Field. This so-called header is followed by the response, which can be transmitted either by the master or by a slave and contains the actual data fields. This response then contains a checksum field. This structure of the messages according to the LIN protocol will be discussed in more detail below.

The master node 1 shown in FIG. 1 is equipped with the abovementioned hardware circuits 2, 3, 4 and 5 for carrying out this LIN protocol, these being without exception hardware circuits and requiring no additional software control.

In the example of embodiment shown in FIG. 1, these hardware circuits have a control unit which in particular composes data that are to be transmitted and coordinates the remaining hardware circuits. Conversely, this control unit is also responsible for receiving messages and evaluating the latter.

The control unit 2 in particular controls a checksum generator 4 which generates the checksums for messages that are to be transmitted and received messages.

There is furthermore provided a checksum comparator 3 which in the case of received messages compares the checksum generated by the checksum generator 4 with the checksum that has been received.

Each message that is to be transmitted is compared, by means of a comparison circuit 5 that is furthermore provided, with the data which actually occur on the single-wire line 9. This is possible since the data of each message that is to be transmitted are reflected back via the transceiver 8 to the control unit 2 and the comparison circuit 5. That is to say the data which the master node 1 has transmitted to the single wire 9 of the LIN network are in turn supplied back by the transceiver 8 in the form in which they actually occurred on the LIN network. The comparison circuit 5 compares these transmitted data with the received data and sends to the control unit 2 a signal that corresponds to the result of the comparison. If they are different, according to the LIN protocol the message that is to be transmitted is terminated by the control unit 2.

If data are to be transmitted by means of the master node 1, the control unit 2 retrieves from the data memory 6 the data supplied by a user (not shown in the figure) via the interface 7. The checksum is generated. The control unit 2 composes the complete message and transmits the latter with the generated checksum in accordance with the LIN protocol via the transceiver 8 to the LIN network or the single line 9 thereof. The above-described comparison of the transmitted and received data then takes place by means of the comparison circuit 5.

In the case where a slave node (not shown in the figure) transmits the data, said data are received by the control unit 2 via the transceiver 8. A checksum is generated on account of the received data and a comparison of the generated checksum with the transmitted checksum value is carried out by means of the checksum comparison 3. The message is received only if the two values match. The data of the message are stored by the control unit 2 in the data memory 6, from where the user (not shown in the figure) can retrieve them via the interface 7.

These processes take place without additional software control and also do not require any additional support by the user or any other software control.

Finally, the structure of a message MF as it should look in accordance with the LIN protocol will be explained with reference to FIG. 2.

A message MF must always have a header HF which at the start has a Synch Break Field. This Synch Break Field consists of one start bit, 9 or more “zero” data bits and one stop bit. Following the Synch Break Field is a so-called Synch Field which has 8 data bits and also one start bit and one stop bit. The same structure has an Identifier Field, which follows the Synch Field.

A problem arises even in the case of this header, since the Synch Break Field has more than the 1+8+1 bits, so that the Synch Break Field can no longer be processed by means of a standard UART controller since the latter is designed only for 1+8+1 in each data block. In order to avoid the solutions known from the prior art in which provision is made for additional programming of these functions which go beyond the UART protocol, the master node according to the invention which is shown in FIG. 1 has the hardware circuits 2 to 5 which manage without any such software control.

The response block RF shown in FIG. 2, which follows the header HF in the message MF, also contains some data fields which in each case have 8 data bits which are preceded in each case by one start bit and are followed in each case by one stop bit. The number of data fields may be variable. Following the message, the checksum is transmitted which is generated from all the data of the data fields.

The generation of the checksum and the sending of the latter and also the generation of the checksum and the comparison of the checksum in the case of received data are likewise functions which cannot be carried out by standard UART controllers. In the master node according to the invention these are likewise carried out by means of the hardware circuits 2 to 5.

1. A master node (1) for a LIN network (Local Interconnect Network) (9), wherein hardware circuits (2, 3, 4, 5) are provided in the master node (1), which hardware circuits are provided to carry out the LIN protocol and take over the behavior of the master during data transmission or data reception without additional processor or software support.

2. A master node as claimed in claim 1, characterized in that a message memory (6) is provided, in which a user assigned to the master node (1) stores data that are to be transmitted, whereupon the master node (1) controls the transmission of the data to the LIN network (9) by means of the hardware circuits (2, 3, 4, 5), or from which the user reads data received and provided via the LIN network by means of the hardware circuits (2, 3, 4, 5).

3. A master node as claimed in claim 1, characterized in that the hardware circuits (2, 3, 4, 5) for carrying out the LIN protocol have a control unit (2) which composes messages that are to be transmitted via the LIN network (9) and processes messages received via the LIN network (9) and stores the content thereof in the message memory (6).

4. A master node as claimed in claim 1, characterized in that the hardware circuits (2, 3, 4, 5) for carrying out the LIN protocol have a checksum generator (4) which generates the checksums of data that are to be transmitted or of received data.

5. A master node as claimed in claim 4, characterized in that the hardware circuits for carrying out the LIN protocol have a circuit for checksum comparison (3) which compares the received checksum of the received data with the generated checksum of the checksum generator (4).

6. A master node as claimed in claim 1, characterized in that the hardware circuits (2, 3, 4, 5) for carrying out the LIN protocol have a comparison circuit (5) which compares data transmitted by the master node (1) with the received data of the same message.

7. A master node as claimed in claim 1, characterized in that the control unit (2) controls the checksum generator (4), the circuit for checksum comparison (3) and the comparison circuit (5).

8. A master node as claimed in claim 1, characterized in that the master node (1) is coupled via a transceiver (8) to the wire (9) of the LIN network.
